(19) United States
(12) Patent Application Publication
(10) Pub. No.: US 2022/0122771 A1
(43) Pub. Date: Apr. 21, 2022

(54) LAYERED CAPACITOR WITH TWO DIFFERENT TYPES OF ELECTRODE MATERIAL

(71) Applicant: Imagine TF, LLC, Campbell, CA (US)

(72) Inventor: Brian Edward Richardson, Los Gatos, CA (US)

(21) Appl. No.: 17/504,320

(22) Filed: Oct. 18, 2021

Related U.S. Application Data
(60) Provisional application No. 63/204,695, filed on Oct. 19, 2020.

(51) Int. Cl. H01G 4/008; H01G 4/30; H01G 4/32

(52) U.S. Cl. CPC H01G 4/008; H01G 4/32; H01G 4/30

(57) ABSTRACT

A capacitor device including multiple layers with at least a first conductor layer fabricated from a first material and located between two dielectric layers. Layered on the first conductor/dielectric layers combination is at least a second conductor layer fabricated from a second material and located between two additional dielectric layers. The first conductor layers are all electrically connected to each other. The second conductor layers are also electrically connected to each other, and are not electrically connected to the first conductor layers.

### CROSS REFERENCE TO RELATED APPLICATIONS

This application claims the priority benefit of U.S. Provisional Application 63/204,695, filed Oct. 19, 2021, entitled “Layered Capacitor with Two Different Types of Electrode Material, inventor Brian Edward Richardson. The disclosure of that application is incorporated by reference herein in its entirety.

### FIELD OF THE PRESENT DISCLOSURE

The present invention is an architecture for the fabrication of capacitors that employ different types of materials for the conductive electrodes. The use of different types of materials allows for the selective etching of one conductive element independent of the other. Selective etching allows for the electrical isolation of a particular conductor during manufacturing. This architecture can be applied to stand-alone capacitors or capacitors incorporated within an integrated circuit (IC).

### SUMMARY

Various embodiments of the present disclosure teach a capacitor generally constructed from at least two different types of electrode conductors. By deploying two different types of material, selective etching can be used to selectively etch the materials during fabrication.

The methodology disclosed herein can be deployed to manufacture stand-alone type capacitors. Stand-alone capacitors utilize layers of electrodes stacked on top of one another. The stacks of electrodes can be configured in a linear or cylindrical configuration. The stacked layers of alternating electrode material can also be deployed within an integrated circuit.

The deployment of the disclosed art greatly reduces the number of and complexity of the process steps required to manufacture capacitors. Further, it allows for, in many cases, roll to roll fabrication of capacitors rather than a batch type approach. When the present invention is integrated within an IC, the real estate required for the necessary capacitors can be greatly reduced.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a perspective view of a printed circuit board populated with various types of capacitors and other electrical components.

FIG. 2 is a perspective view of one of the chip capacitors shown in FIG. 1.

FIG. 3 is a closeup, sectioned perspective view illustrating the two ends of the chip capacitor shown In FIG. 2.

FIG. 4 is a closeup perspective view illustrating only one end of the chip capacitor shown in FIG. 2.

FIG. 5 is a perspective view of the chip capacitor shown in FIG. 2 in an initial processing state.

FIG. 6 is a perspective view of the chip capacitor shown in FIG. 2 in a successive processing state.

FIG. 7 is a perspective view of the chip capacitor shown in FIG. 2 in a further successive processing state.

FIG. 8 is a perspective view of the chip capacitor shown in FIG. 2 in a still further successive processing state.

FIG. 9 is a perspective view of the chip capacitor shown in FIG. 2 in a still further successive processing state.

FIG. 10 is a perspective view of the chip capacitor shown in FIG. 2 in a still further successive processing state.

FIG. 11 is a perspective view of an alternate embodiment of the capacitor wherein the layered films are deployed in a cylindrical configuration.

FIG. 12 is a perspective view of an alternate embodiment of the capacitor wherein the layered films are deployed in an IC (integrated circuit).

FIG. 13 is a sectional view of the capacitor illustrated in FIG. 12.

FIG. 14 is a detail view of the capacitor illustrated in FIG. 13.

FIG. 15 is a sectional view of another alternate embodiment of the capacitor wherein an additional insulation layer is deposited during the fabrication process.

FIG. 16 depicts the portion of the capacitor shown in FIG. 15 following a successive process step.

FIG. 17 is a perspective view of an alternate embodiment of the capacitor device wherein three stacks have been layered on top of one another.

FIGS. 18A-D are perspective views of an alternate embodiment wherein the substrate and the layered stack(s) are trenched.

FIGS. 19A and 19B are perspective views of an alternate embodiment orientated as assembled onto a PCB.

FIG. 20 is a detailed perspective view of a portion of the embodiment shown in FIGS. 19A and 19B.

FIGS. 21A-C are inverted perspective (upside down) views of the alternate embodiment shown in FIGS. 19A-B.

FIGS. 22A and 22B are perspective views of the alternate embodiment shown in FIG. 20 at an initial stage of fabrication.

FIGS. 23A and 23B are perspective views of the alternate embodiment shown in FIG. 21 after further processing.

FIGS. 24A-B show perspective views of the alternate embodiment shown in FIG. 22 after further processing.

FIGS. 25A-B are perspective views of the alternate embodiment illustrated in FIG. 23 after further processing.

FIG. 26 Is an electrical diagram of a capacitor.

FIGS. 27 through 31 show reference materials and prior art.

### DETAILED DESCRIPTION

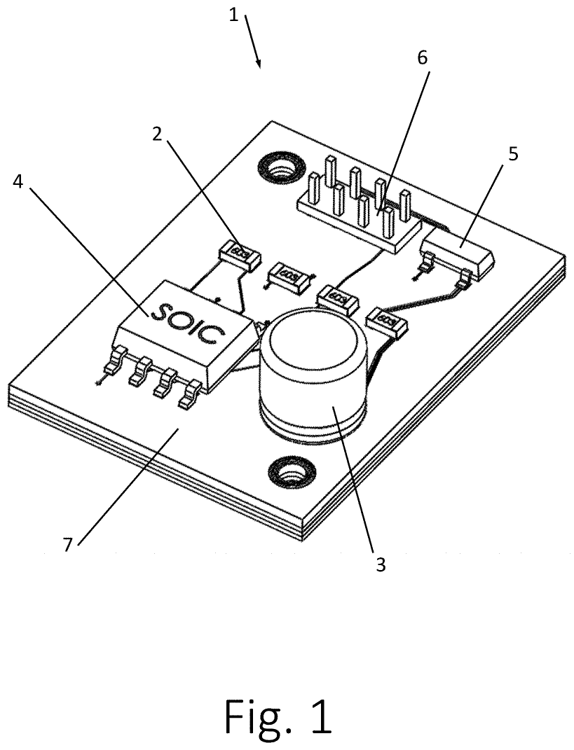

FIG. 1 is a perspective view of a PCB assembly 1 with multiple electrical components assembled onto a PCB substrate. Various types of components are shown attached to the PCB board 7. The components illustrated include a chip capacitor 2, a cylindrical capacitor 3, an IC (integrated circuit) 4, a transistor 5, and a connector 6, all assembled on PCB board 7. The components listed, as well as other relevant components, are well known in the electronics industry. The components listed are typically soldered to the PCB board 7 with a metal-based solder. In some cases, the components may be assembled using conductive ink. One knowledgeable in electronic circuitry could configure components in an unlimited number of configurations to accomplish the needs of the PCB assembly 1.

Two different types of mechanical capacitors are shown—the rectangular chip capacitor 2 and the cylindrical capacitor 3. Most IC devices 4 include capacitors that are integrated into the device.

On a fundamental level, capacitors are devices that store electrical charge. Almost all electronic devices have them. Some devices have millions of them. For example, a DRAM IC might have more than a trillion capacitors. An LCD display may have tens of millions of capacitors. A PCB assembly may have hundreds of discrete capacitors.

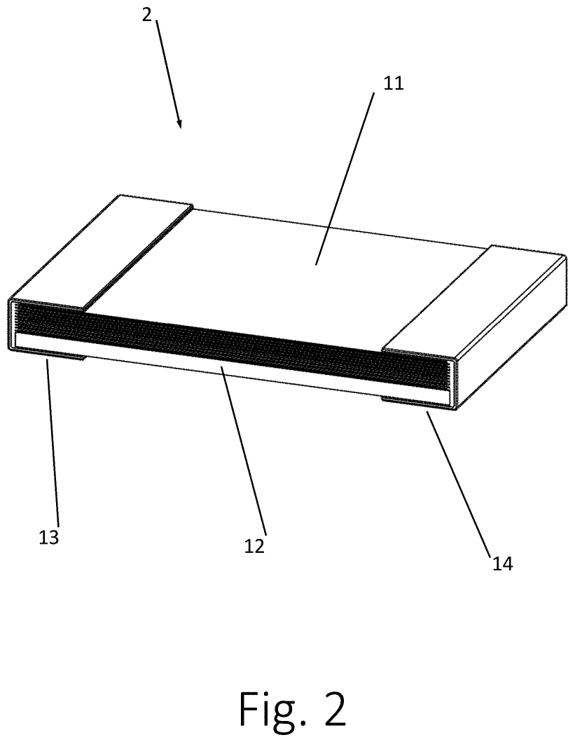

FIG. 2 is a perspective view of one of the chip capacitors 2 shown in FIG. 1. The chip capacitor 2 includes a main section with a layered stack 11 that is mated to the substrate 12. The substrate 12 is not required for the function of the capacitor 2. The substrate 12 provides structure during manufacturing and handling of the device. The substrate 12 is fabricated of a material that is not conductive. At opposite ends of the chip capacitor 2 are a first plated pad 13 and a second plated pad 14. The plated pads 13 and 14 facilitate electrical and mechanical connections to the PCB 7.

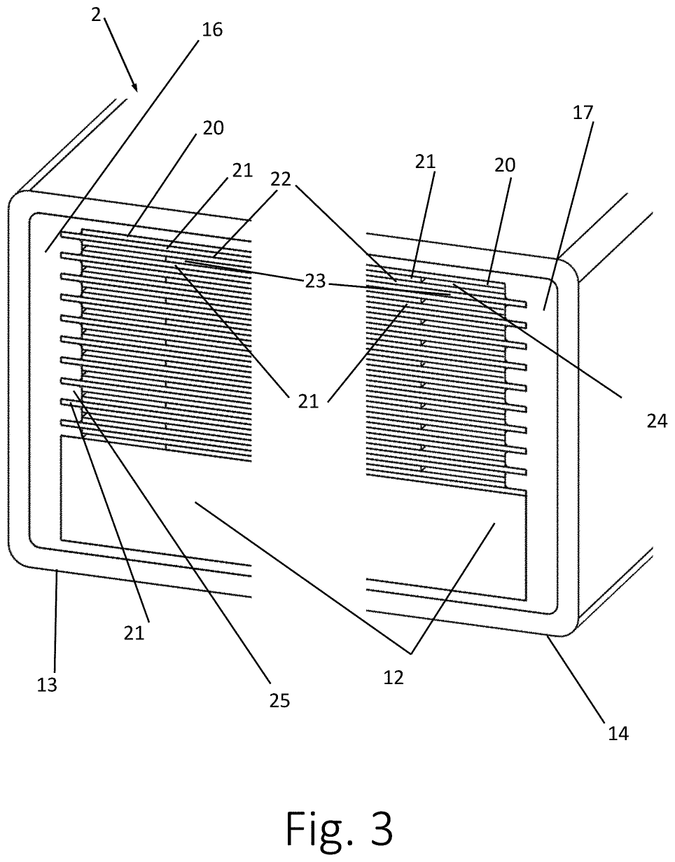

FIG. 3 is a detailed view of the ends of the chip capacitor 2 with the ends enlarged to show further details. The various layers of the layered stack 11 (FIG. 2) are shown in detail in FIG. 3. The layered stack 11 includes alternating layers of conductors and dielectrics. The top layer of the layered stack 11 is a dielectric top layer 20. The top layer 20 insulates the conductive layers from the exterior of the device. Directly below the top layer 11 is a first conductive layer 21 that is mated to the top layer 20. Directly below and mated to the first conductive layer 21, is a first dielectric layer 22. Directly below and mated to the first dielectric layer 22, is a second conductor layer 23. Alternating dielectric and conductive layers follow below. The sequence of layers is repeated in a number according to the requirements of the subject installation, and ends where the layered stack 11 is mated to the substrate 12.

The number of and thickness of the layers is not shown to scale. For most applications, the number of layers would be much greater than what can be readily illustrated, and the layers would be much thinner than depicted. Conductor layers and dielectric layers may be only a few nanometers in thickness. Thinner conductors equate to greater capacitance. Therefore, thinner conductor layers equate to a thinner device manufacturable at a lower cost.

As mentioned above, capacitors store electrical charge. A charge can be created across the dielectric layer by applying a voltage across the layer via conductors. The charge can then be extracted from the capacitor for use in an electrical device. The unit used to measure capacitance is Farads. Small capacitors may only have a fraction of a microFarad in capacitance. Larger capacitors may have a Farad or more. The equation for capacitance of a capacitor based on its geometry and physical characteristics is:

C (Farads)=e₀×k×[(L×W)/T]×Nc

### Where:

e₀: The permittivity of free space, a physical constant=8.85×10⁻¹² m⁻³ kg⁻¹ s⁴ A²

k: The dielectric constant of the dielectric layers 22, unitless

L: The length of the layers in meters

W: The width of the layers in meters

T: The thickness of the dielectric layer in meters

Nc: number of active dielectric layers

The permittivity of free space is a physical constant and is the same for all types of capacitors of any type of construction. The dielectric constant, k, is a property of the dielectric material used in the dielectric layers 22. Dielectric constants for dielectric materials range from around 4 for silicon dioxide to greater than 2000 for strontium titanium oxide. One skilled in the art of capacitor materials could engineer the selection of the dielectric for a particular application of the chip capacitor. It is generally desirable for the length and width of the capacitor to be as small as possible. It is likewise desirable to make the thickness of the capacitor as thin as possible. Larger and thicker capacitors not only require more real estate within a PCB, but they also utilize more material which leads to cost increases. The number of layers, Nc, also effects the cost, and to a lesser degree size.

A typical current art chip capacitor may have a dielectric constant, k=1,000; a length, L=1.0 mm; a width, W=0.6 mm; a dielectric layer thickness, T=0.10 mm and have 25 layers, Nc. A capacitor with these parameters would have a capacitance of 0.00133 microFarads.

With the technology disclosed herein, the dielectric layers 22 can be much thinner than in current art devices, T=0.0001 mm (or 1,000× thinner). This results in a capacitor with 1,000 times the capacitance of a standard thickness component, or 1.33 microFarads, while utilizing the same physical size requirements and dielectric material.

The reduction in dielectric thickness is possible due to the ease of manufacturing devices using the disclosed technology. Current art processes require that the layers forming the component be relatively thick. The disclosed art allows for the use of modern semiconductor type processes which allow much thinner layers to be produced. The current state of the art of semiconductor type deposition processing allows for the deposition of one layer of atoms at a time. The deposition process allows for the creation of extremely thin conductor and dielectric layers.

One skilled in the art of semiconductor deposition could readily engineer the ideal deposition process for a particular application of a chip capacitor. A capacitor using the presently disclosed technology to meet the specs of the capacitor mentioned above could be much smaller in area (W×L), 1/1,000, of the area required with current art devices. The capacitor of the stated specifications would be only 0.06 mm×0.1 mm, rather than 0.6 mm×1.0 mm, and would still have 10 times the capacitance.

Referring again to FIG. 3, the connections of the first conductor 21 to a first contact 16 can be seen. It should be noted that only the first conductor 21 makes contact to the first contact 16. The second conductor 23 does not make contact with the first contact 16. The second conductor 23 only makes contact with the second contact 17, and does not make contact with the first conductor 21. This pattern repeats throughout the stack.

It is generally preferred to have the material of the contacts surround the ends of the conductor material. As illustrated in FIG. 3, the first conductor 21 makes contact with the first contact 16, but does not make contact with the second conductor 23. Similarly, the second contact 17 makes contact with the second conductor 23, but not the first conductor 21. The second conductor 23 does not make a connection with the first contact 16 due to a gap 24. To ensure electrical contact and mechanical strength, some of the conductive ink flows between the first contacts as a contact fill 25. As shown in FIG. 3, the contact fill 25 may extend to the dielectric layers 22.

A conductive ink is commonly utilized in the chip capacitor industry to fabricate the first contact 16 and the second contact 17. The proper selection of conductive ink and the proper application of the ink during fabrication ensures contact to the appropriate conductors while ensuring the gap 24 is not filled with ink so as to make unwanted contact.

The first contact 16 and the second contact 17 are encased with plated pads 13 and 14, respectively. The plated pads 13 and 14 are also typically deployed in current art devices. The contacts 16 and 17 are typically electroplated or electroless plated. Many processes apply multiple types of materials to improve ease of soldering, conduction, and/or corrosion protection. One skilled in the art of chip capacitor contacts and plating could engineer the optimal configuration of these elements for a particular application of the chip capacitor.

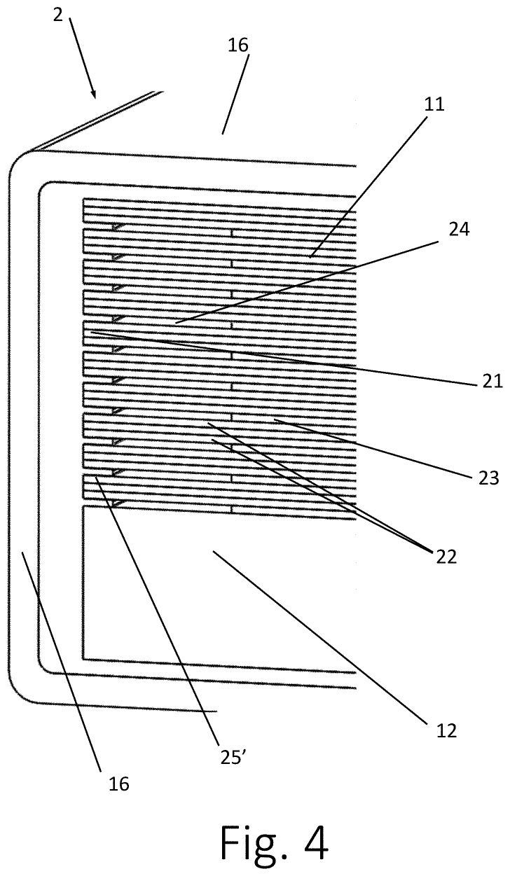

Referring now to FIG. 4, a slightly different embodiment of the capacitor device is shown. In this embodiment, the material of the dielectric layers 22 extends outward at the same distance as the conductors 21, 23. This embodiment takes fewer steps to manufacture, but provides less certainty that a good connection is made between the conductor and the contact.

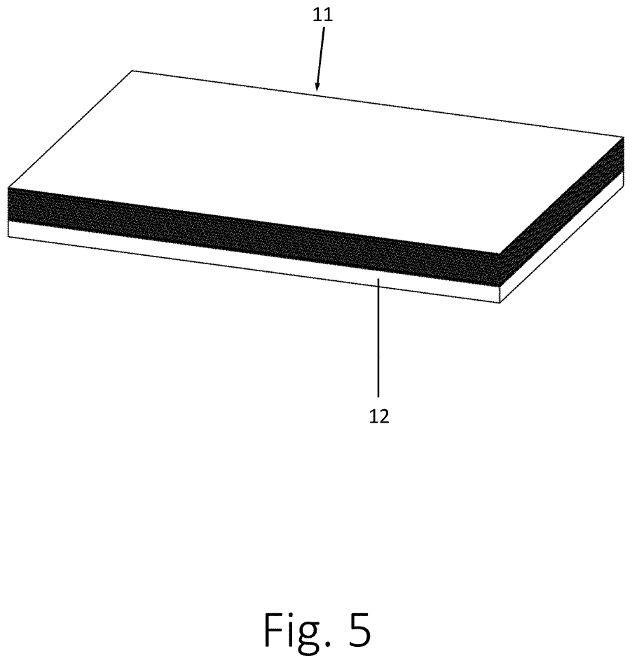

FIG. 5 shows the first phase of the manufacturing process for the embodiment illustrated in FIG. 4. In this step, dielectric layers 22 and conductive layers are placed on top of the substrate 12. Large sheets or rolls of substrate material can be processed and cut into smaller sections as required for a given application. Deposition of layers on large sheets or rolls is a common process. A commonplace everyday example of this type of roll-to-roll coating of a conductor on a substrate is packaging for potato chips. Most products of this type have an aluminum coating applied. The type of machine that creates the aluminum film can be used to apply dielectrics and many other types of conductors. Coating of glass for displays is another example of a process in which thin layers of conductors and dielectrics are applied with a high degree of accuracy to a substrate. These coating processes also have the advantage of being relatively low cost.

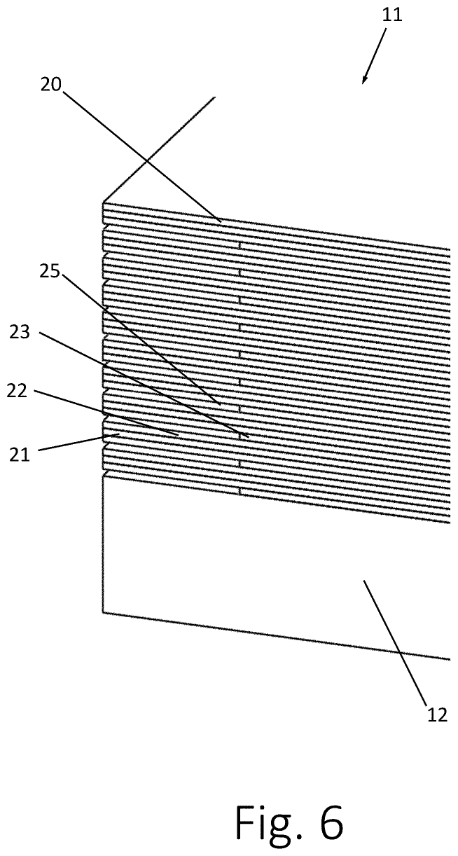

FIG. 6 shows a second phase of the fabrication of the device first illustrated in FIG. 4. The first conductor layer 21 is shown to extend outward to the same degree as the dielectric layers 22, while the second conductor layers 23. This provides the formation of gaps 25. The staggering of the layers is accomplished by selecting an etchant that etches only second conductor 23 and not first conductor 21 or dielectric 22. To create this selectivity, the materials for the two conductors 21, 23 are different. For purposed of discussion, the first conductor 21 may be fabricated from copper, Cu, and the second conductor 23 from aluminum, Al, with the dielectric layers 22 being made from silicon dioxide, SiO₂. A solution of potassium hydroxide could be deployed to accomplish the selective etching. Potassium hydroxide aggressively etches the Al of the second contacts 23 while negligibly affecting the Cu of the first conductors 21 or the SiO₂ dielectric layer 22.

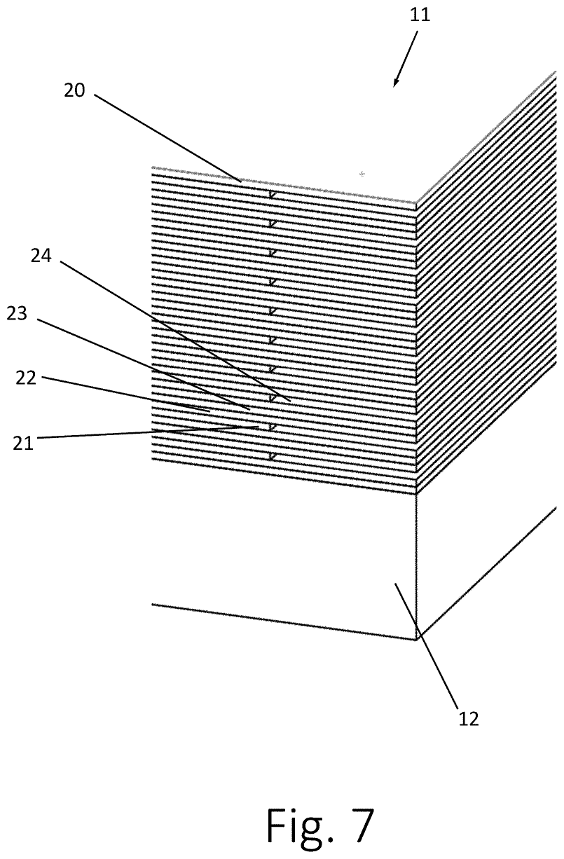

FIG. 7 illustrates a third phase of fabrication. The Cu of the first conductors 21 is etched back, while the Al of the second conductors 23 and the SiO₂ of the dielectric layers 22 have not been etched. An etch solution of Cu+FeCl₃ can be deployed to accomplish this task. One skilled in the art of chip conductor fabrications and or etching of conductors could engineer many different combinations of conductor materials and etchants for a given application of the chip capacitor.

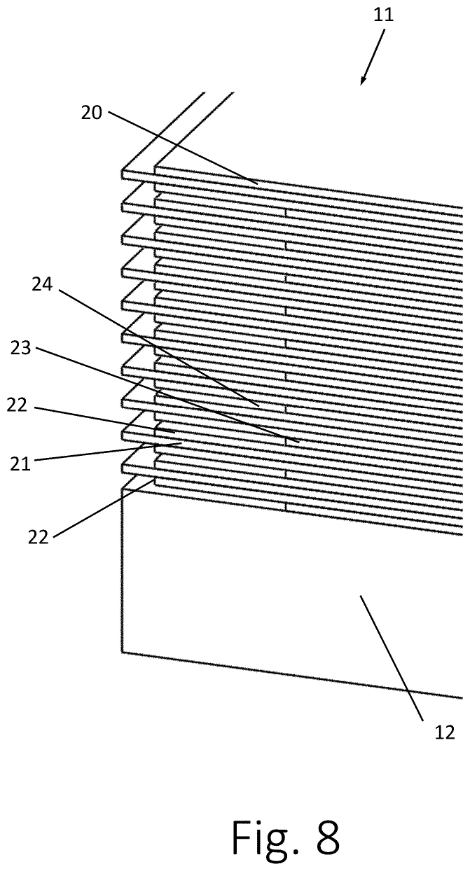

FIG. 8 shows a further (fourth) phase of processing. In this phase, the dielectric layers 22 are etched back. As mentioned above, the etching of the dielectric layers 22 is desirable but not required. Further, for some conductor and dielectric materials, the etching task could be accomplished by a single etchant. In other words, an etchant could be selected that aggressively attacks one of the conductors, mildly attacks the dielectric, and doesn't attack the second conductor at all.

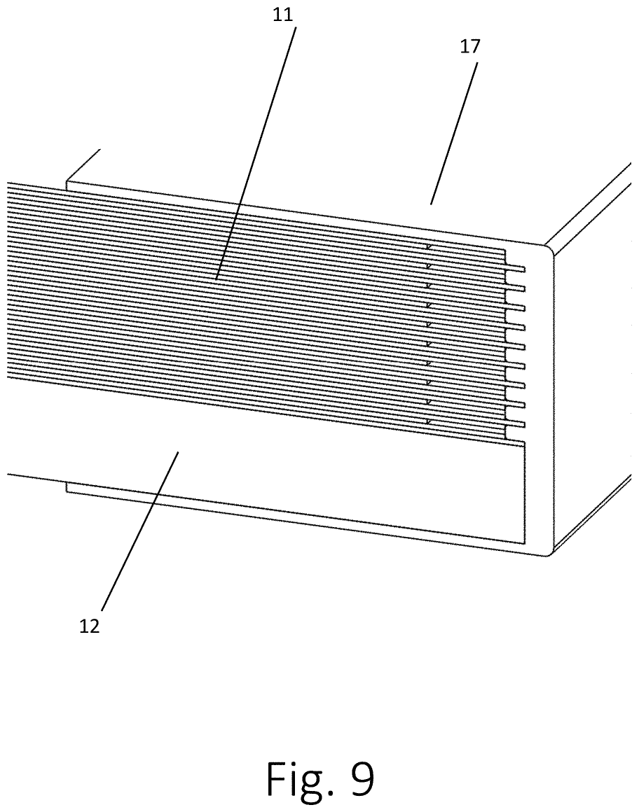

FIG. 9 shows a still further phase (a fifth step) of the manufacturing process. In this phase, the application of the contact is accomplished. The present invention uses known techniques for contact fabrication. The results of the current art practice of dipping the end of the layer stack in conductive ink is shown in FIG. 9.

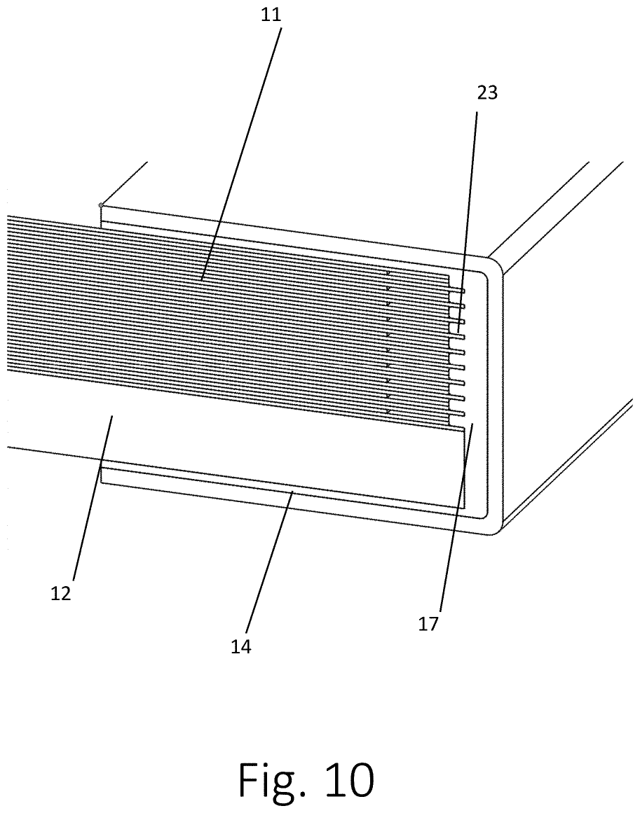

FIG. 10 shows the addition of plating to the conductors. Only one plating layer is shown. A two or three step plating process could just as easily be deployed. By deploying two different types of conductor layer materials within one device, manufacturing complexity and cost is greatly reduced, and performance is greatly improved. The size of the resultant capacitors can also be reduced.

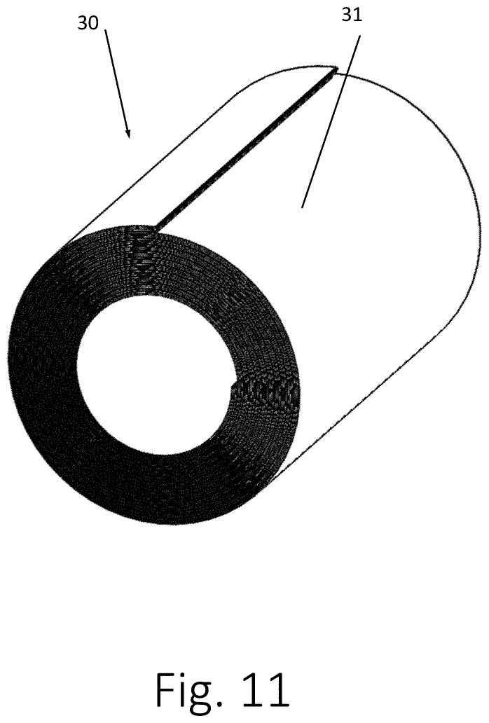

FIG. 11 shows an embodiment of the present technology deployed in a cylindrical configuration 30. The embodiment employs the use of two different types of conductors, i.e. two different conductor layer materials. The substrate material is of a type or thickness that allows it to be rolled into a cylinder 31. When glass is extremely thin it can be rolled into a cylinder. Plastic materials may be preferred. A highly bendable material allows for roll-to-roll deposition. Roll-to-roll deposition is a low cost, highly developed technology. Food film bags and other types of packaging utilize roll-to-roll processing to coat the surfaces with metals and dielectrics. Layered stacks that are created with roll-to-roll processing can be utilized in the processing disclosed herein for a flat chip capacitor as disclosed above in the various embodiments described.

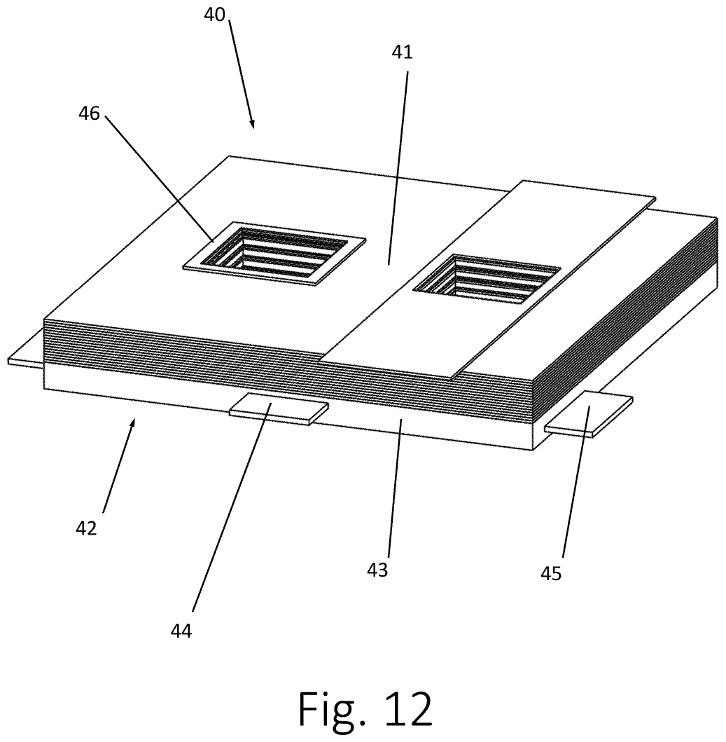

FIG. 12 shows an IC with an integrated capacitor according to the present invention. An IC with integrated capacitor 40 is shown with the IC layered stack 41 atop the IC active area 42. The IC active area 42 may have many other types of electrical components within it; transistors, resistors and diodes. These devices can be arranged and connected in an infinite number of ways. Their configuration is beyond the scope of this invention. Further, a typical IC would be much larger than that illustrated in FIG. 12. Only a small section of what would typically be included in a larger IC device is shown for purposes of discussion. Bit line 44, word line 45, and top connector 46 depict connect means to adjacent areas of the IC.

The IC layer stack 41 is, in many ways the same as the previously mentioned stack.

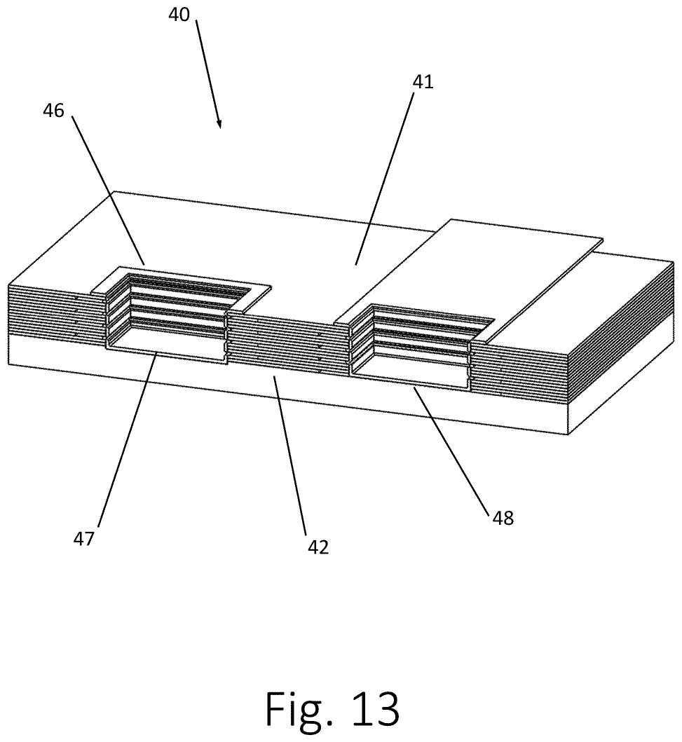

FIG. 13 shows a cross section of the IC capacitor 40 is shown. The bottom of the IC connector pad 46 makes electrical connection with a conductor on the top side of the IC active area 42. The IC capacitor only makes one connection to the IC active area 42 at the IC connection 47. At no other point is there any electrical connection between the IC capacitor and the IC active area 42. Again, only what would typically be a small section of an IC is shown. An IC illustrated in its entirety would typically have thousands of connections and components. The insulated connection 48 of the top conductor 46 does not make electrical connection to the IC active area.

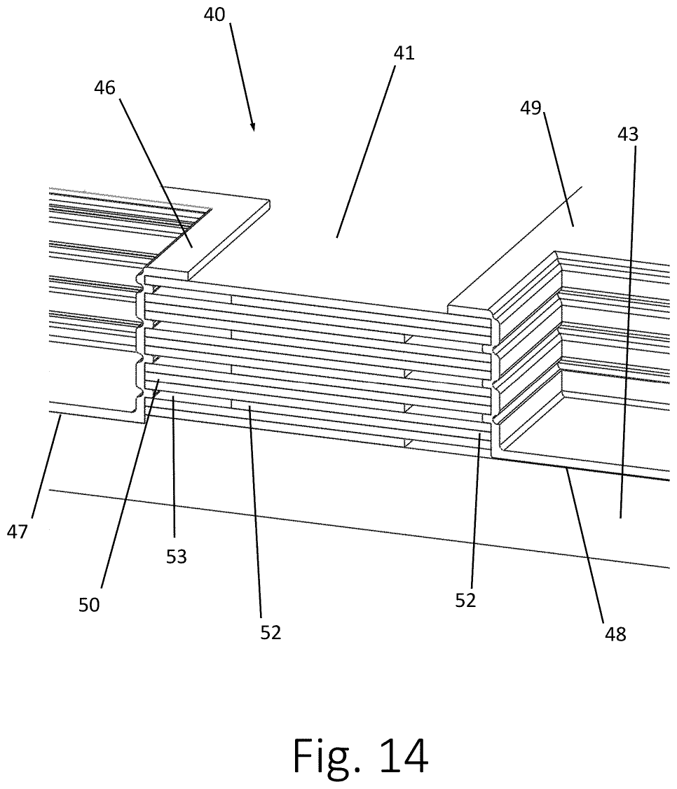

FIG. 14 is a magnified view showing the details of the IC capacitor 40. Multiple layers of dielectrics and conductors made from two different types of materials are shown. In this embodiment, the layers make connections to the perimeter of square shaped pads. A first IC conductor 50 does not make an electrical connection to IC connector pad 46 while a second IC conductor 52 does not make an electrical connection to the IC connector pad 46. The IC dielectric layers make contact with the IC connector pad 46. The second IC conductor 52 does make an electrical connection to top conductor 49 but the top conductor 49 does not make a connection with the first IC conductor 50. IC gaps 53 insure the lack of connections where desired._{#}

The chip capacitor illustrated in FIG. 10 uses a known method of creating the connector pads 46, which is the use of conductive ink. This practice is not optimal for semiconductor processing used in the fabrication of ICs. For the fabrication of an IC (see FIG. 14), a CVD or PVD process is preferred. These processes do not fill wide lateral pockets well. They especially do not fill pockets that are short and long, such as those depicted as IC gaps 53. The deposition of the IC connector pad 46 does fill and connect all of the corresponding IC first conductors 50. The deposition of the IC connector pad 46 does partially fill the IC gap 53. The IC gap 53 is wide enough that good electrical insulation between the IC connector pad 40 and the second IC conductor 52 is maintained. It should be noted that the buildup of deposited material fills a small portion of the entrance of the gap 53 but not deep into the gap. By filling the entrances, all of the IC first conductors 50 are electrically connected, and similarly all of the IC second conductors 52 are also electrically connected.

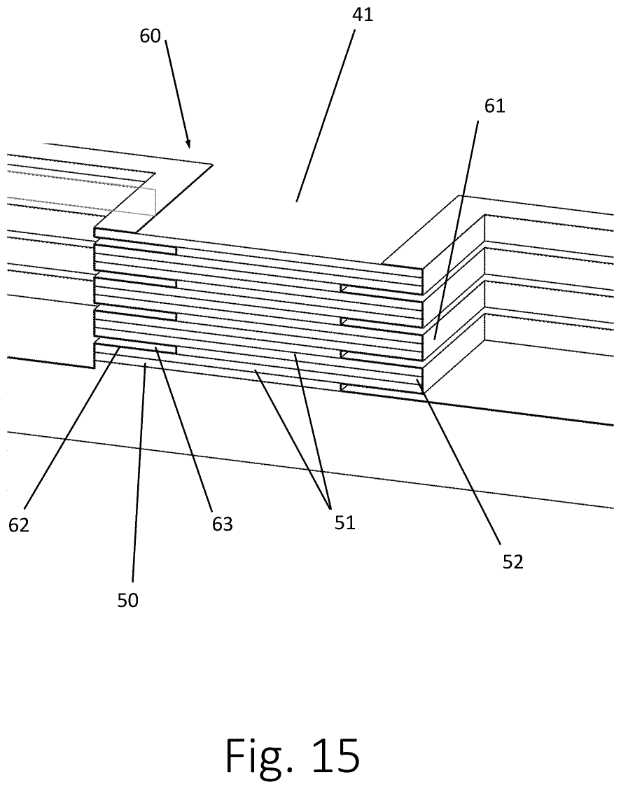

FIG. 15 shows an alternate embodiment of the capacitor device that includes the addition of a process step before the fabrication of the IC connector pad 46 and the top conductor 49. In the embodiment shown in FIG. 15, a conformal insulating layer 62 is applied to the exposed surfaces of the conductors, dielectrics and other exposed areas. The process of atomic layer deposition is ideal for this task. It is highly conformal in that it can coat all of the surfaces that are short and long, such as ALD (atomic layer deposition) gaps 63.

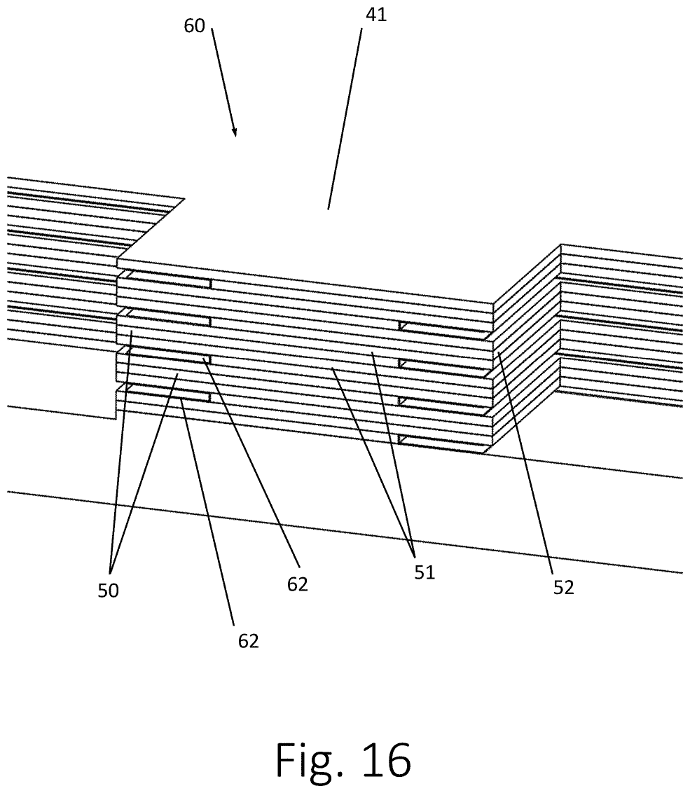

FIG. 16 shows a device in which a portion of the conformal insulating layer 62 has been etched away. By using a directional etching process, for example RIE (reactive ion etching), exposed portions of the conformal insulating layer 62 are etched away. The RIE etching process will etch away some of the conformal insulating material 62 at the entrance of the ALD gap 63. With RIE the ALD material within the gaps is not readily etched. By adding the conformal ALD deposition and the non-conformal etching processes, the likelihood of an unintended connection is greatly reduced. The ALD process and subsequent non-conformal etch are relatively inexpensive manufacturing processes. By employing these processes, the width of the gaps 63 can be reduced. The additional cost of the two processes is offset by the reduction in the time required to etch wide gaps. It should be noted that the above conformal deposition and non-conformal processes could be applied to all of the disclosed embodiments.

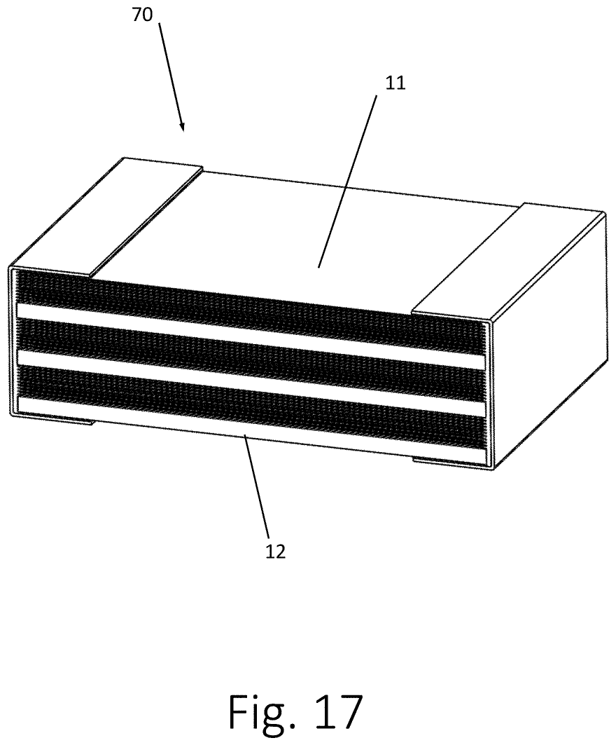

FIG. 17 shows another alternate embodiment 70 of the preferred invention. In this embodiment, three layered stacks 11, along with three substrates 12, are stacked on top of one another. The number of stacks can be much greater than three. This embodiment of the capacitor device might be chosen to be deployed in applications in which a large capacitance is required.

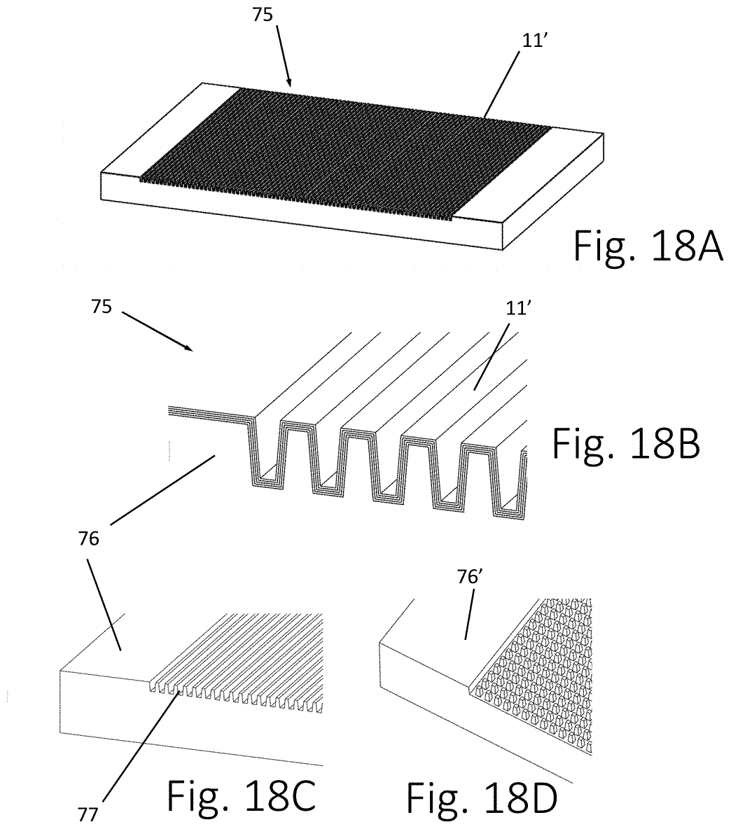

FIG. 18 illustrates yet another embodiment of a substrate layer 74. This embodiment introduces trenching of the substrate. A trenched substrate 76 has an array of deep trenches 77 on the surface 11′ that supports the layered stack. When the trenched substrate 76 is coated with conductors and dielectrics, the overall surface area of the dielectric and conductors is increased. The trenched surface area of the illustrated device increases the capacitance by a factor of three over that of a similar device without a trenched surface. This increase in capacitance is gained without increasing the overall size of the subject capacitor. It should be noted that the above trenching processes could be utilized in any and all of the embodiments disclosed herein. The trenches should be wider than twice the total thickness of the conductors and the dielectrics. Deeper trenches result in greater surface area that results in greater capacitance. The depth is limited only by the fabrication method and does not have the same limitations as the width of the trenches.

FIG. 18D shows a variant of the trenched stack embodiments. The trenched substrate 76′ utilizes posts rather than parallel grooves to achieve the increase in surface area.

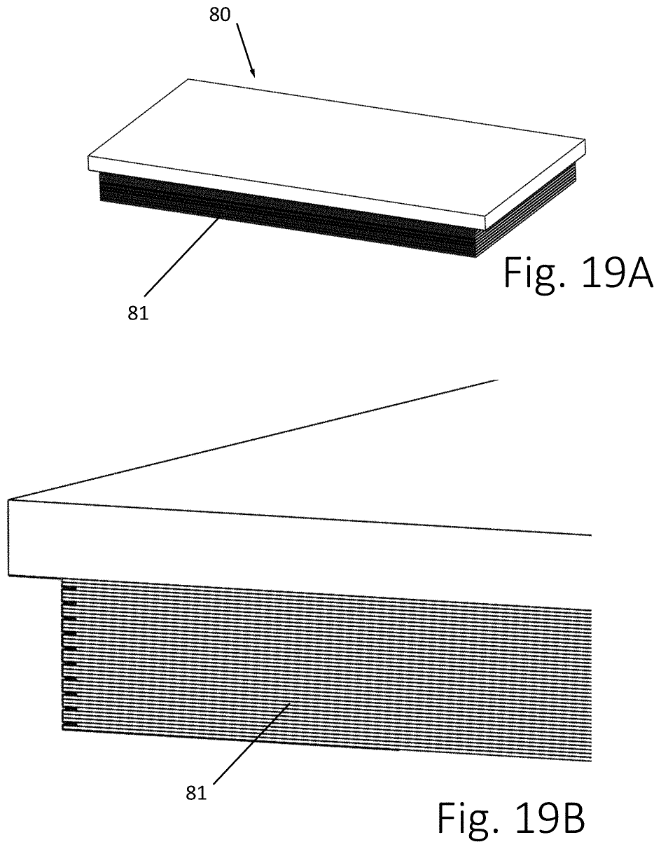

FIGS. 19A and 19B depict still another embodiment of the present invention. This embodiment is tailored to manufacturing of a chip type device with semiconductor equipment and no conductive ink. FIGS. 19A and 19B show an inverted chip 80 in the orientation in which it would be assembled to a PCB. FIG. 19B shows some details of the layered stack 81.

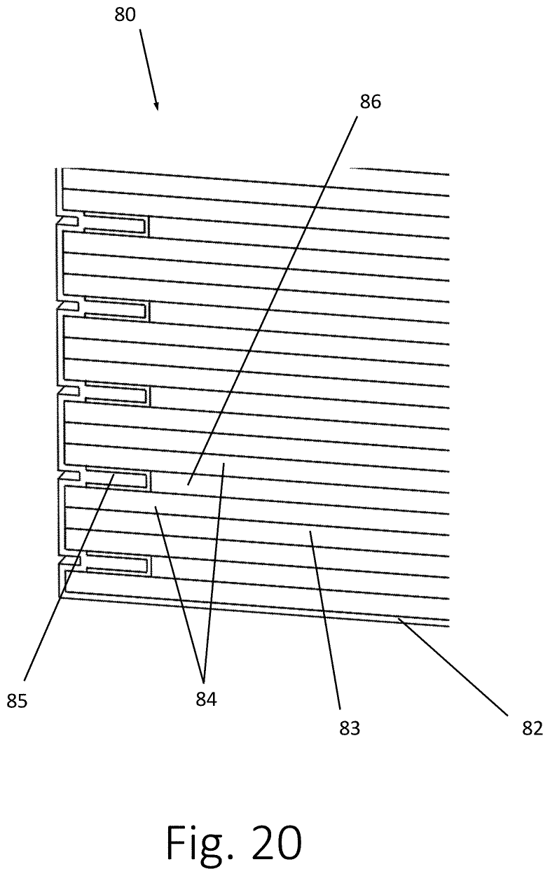

FIG. 20 shows the layers of the inverted chip 80 in even greater detail. This embodiment differs from the preferred embodiments in that it deploys the previously disclosed conformal insulator and non-conformal etch process. It also employs a conformal contact conductor 82. The layers present in the inverted chip 80 are equivalent to those in the normally oriented chip. The inverted chip 80 includes first conductor layers 83 and second conductor layers 86. The conductor layers are sandwiched by dielectric layers 84. The inverted chip 80 is also depicted as including an insulation layer 85.

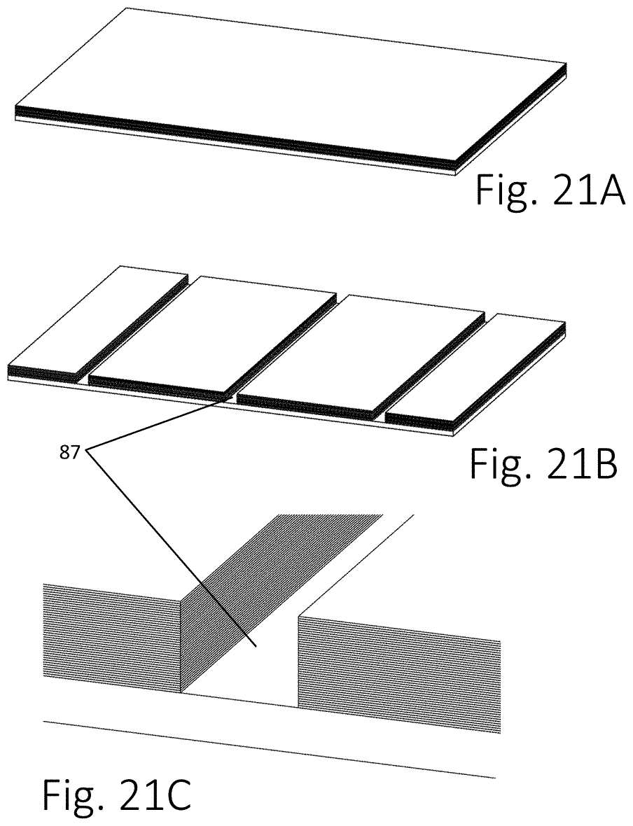

FIGS. 21 through 26 show the process steps required to fabricate another capacitor device. FIG. 21A illustrates a large sheet of substrate material coated with many layers of dielectric and two types of conductor materials.

FIG. 21B shows the layers with multiple grooves 87. The grooves 87 extend down to at least the surface of the substrate. Semiconductor pattern and etch processing, or a laser, is deployed to create the grooves 87. FIG. 21C shows a closeup of the groove 87.

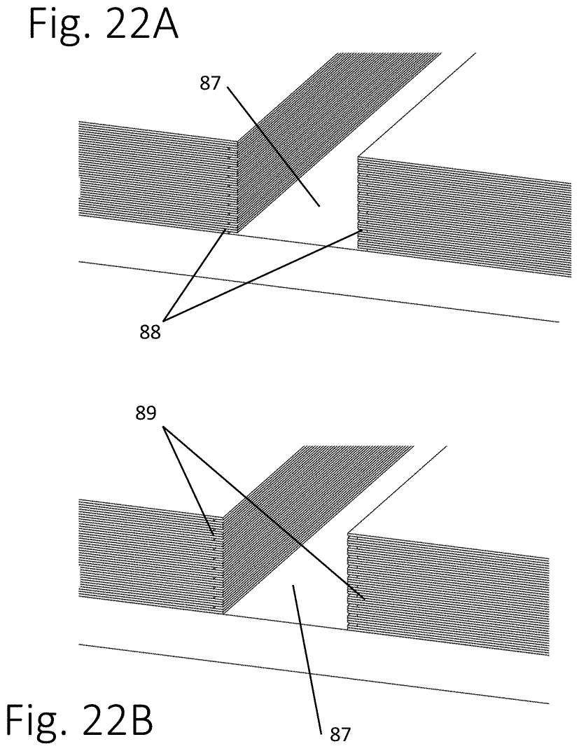

FIGS. 22A and 22B show selective etching of the two types of conductor materials. Both sides of the groove 87 are etched with an etchant. The groove 87 shown in FIG. 22A is etched with a different etchant than the groove 87 shown in FIG. 22B, thus creating a first gap 88 in a first metal, and a second gap 89 in a second metal.

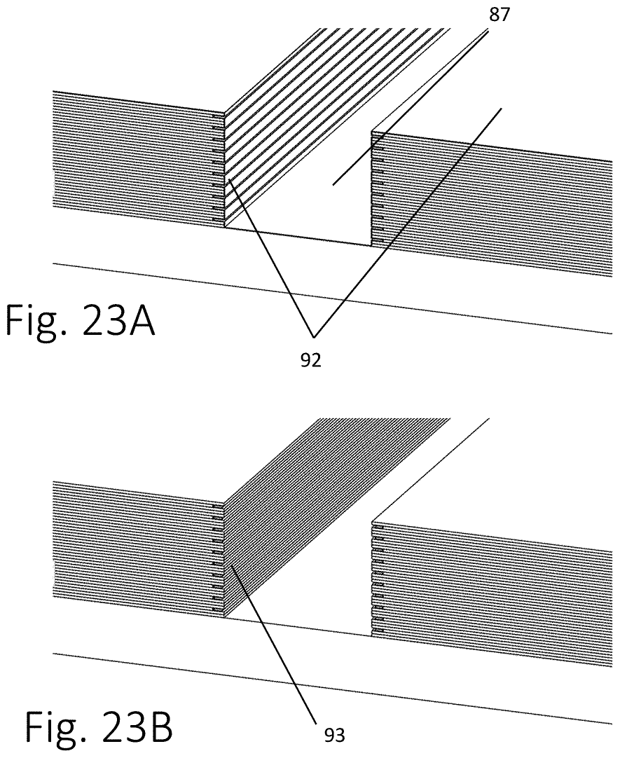

FIG. 23A illustrates the application of a conformal insulating layer 92.

FIG. 23B illustrates a selectively etched conformal insulating layer 93.

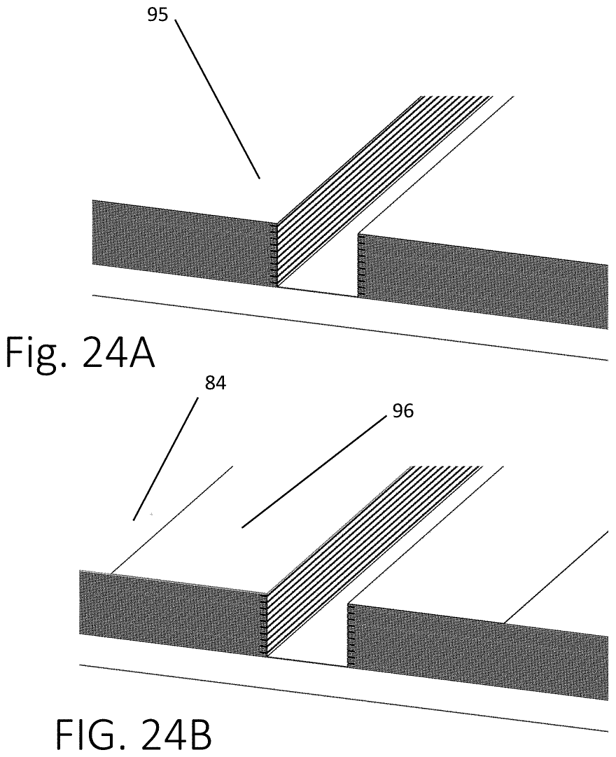

FIGS. 24A and 24B depict the deposition of a pad layer 95 and the subsequent partial etching of the pad layer 95 to create contact pads 96.

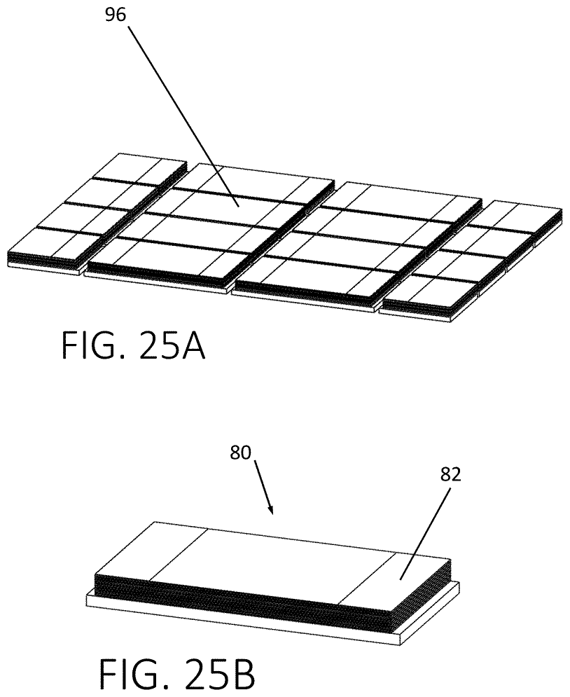

FIGS. 25A and 25B depict the final two steps in the creation of a chip type capacitor. FIG. 25A shows a large sheet diced into chips. Dicing is a common practice in the semiconductor industry. It can be accomplished with a saw type blade, scribing, or by a laser.

FIG. 25B shows one of the diced chips. This chip would be turned upside down when being assembled to a PCB. The pads 96 provide electrical and mechanical connection points to the PCB.

Many types of conductor and dielectric materials have been discussed herein. For conductors a thin coating of a conductor on the surfaces of one of the conductors may be deployed for durability or to add to the electrical characteristic of the capacitor. The dielectric layer may also be comprised of multiple materials. One skilled in conductor and dielectric selection of capacitors could devise many combinations. A polarized capacitor could be created by adding intermediate layers of material. Again, one skilled in the art could engineer many solutions to a particular problem. Further, the dielectric layers could be a porous material or even a liquid or gel.

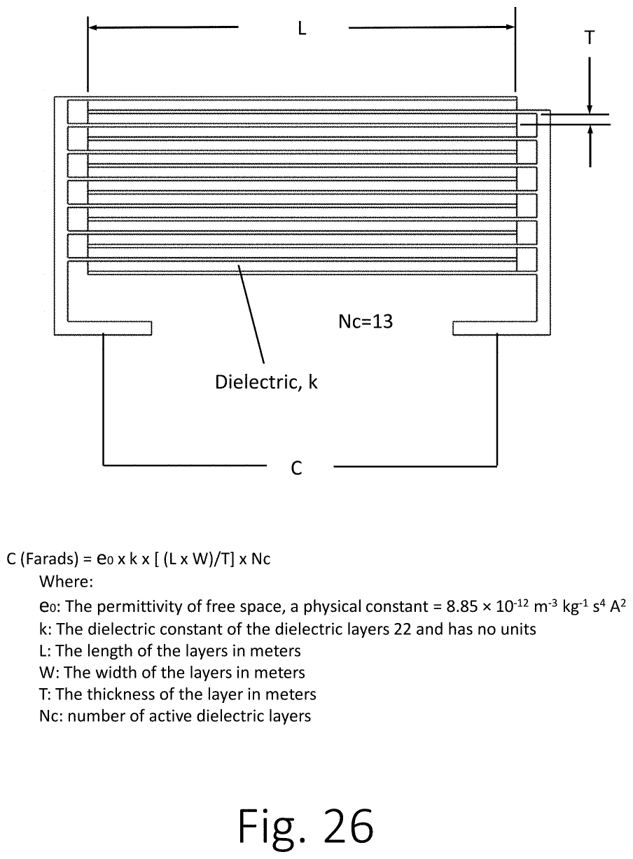

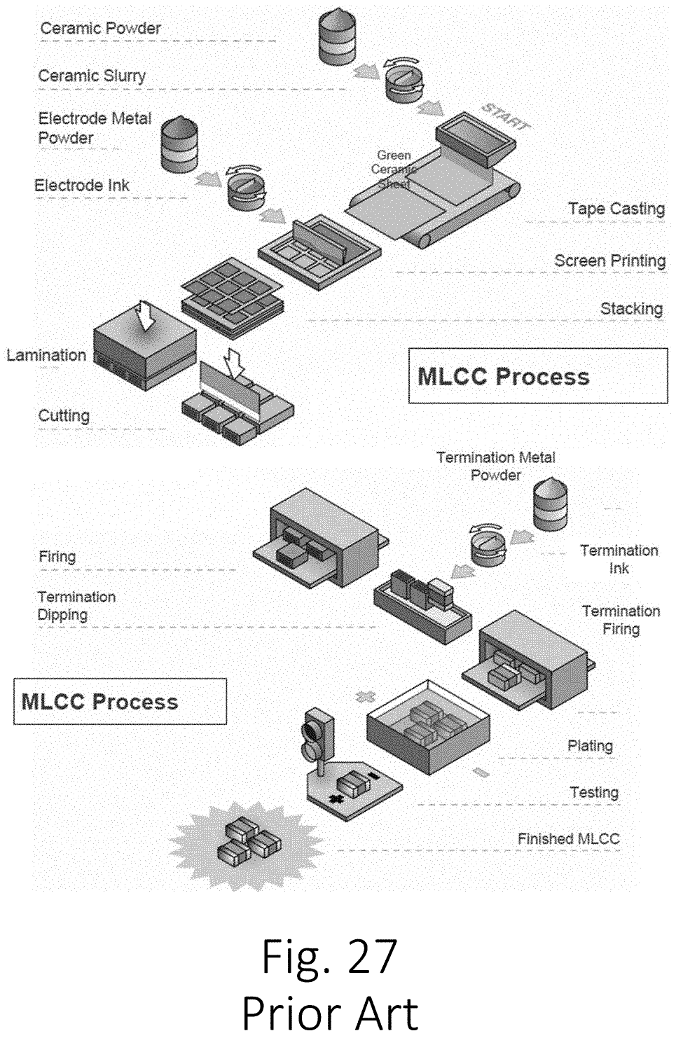

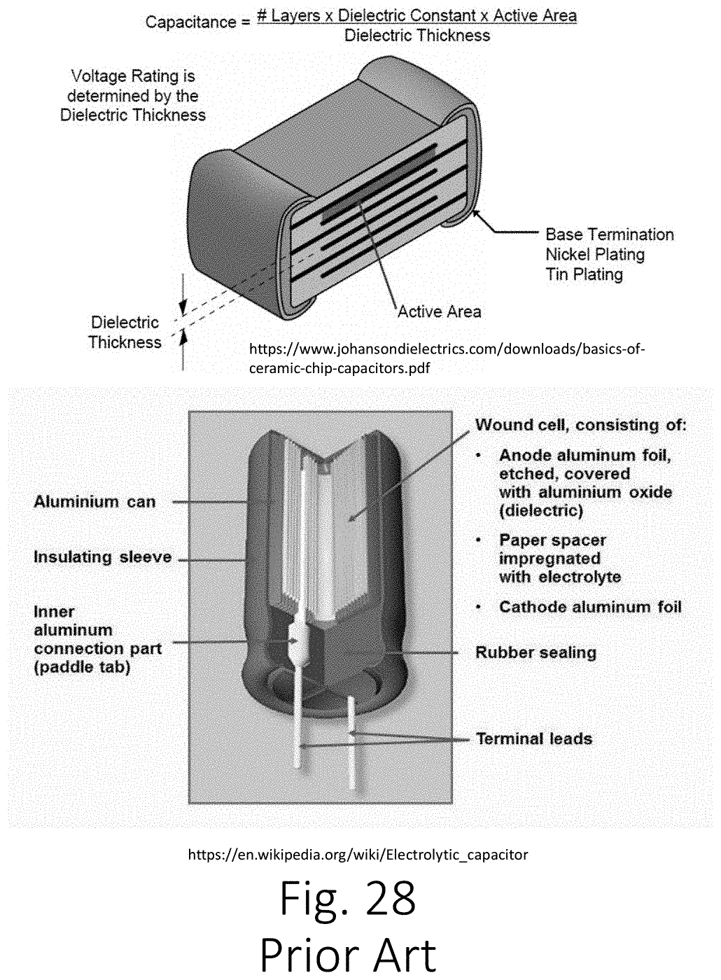

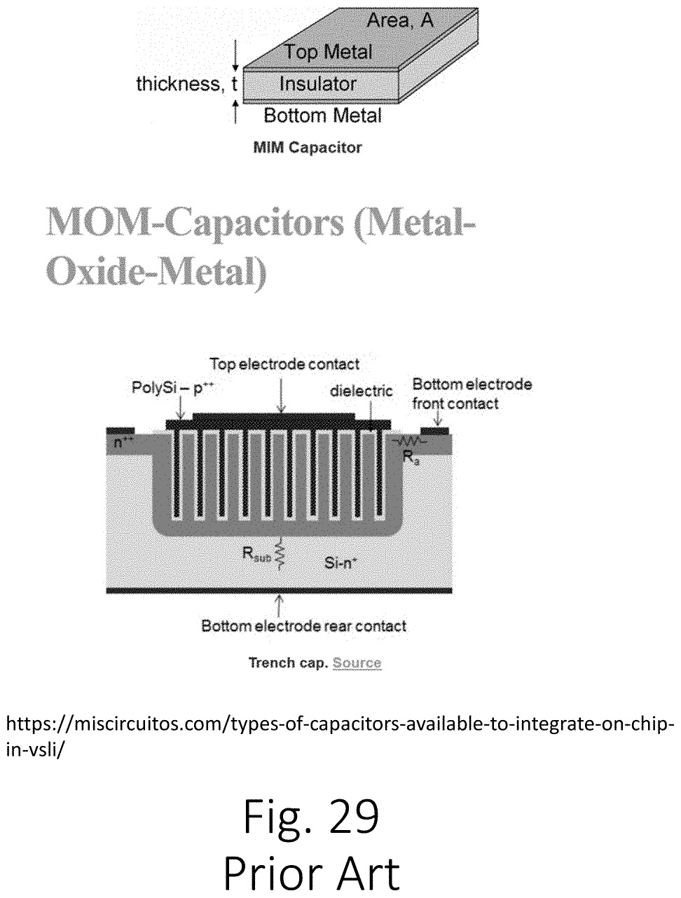

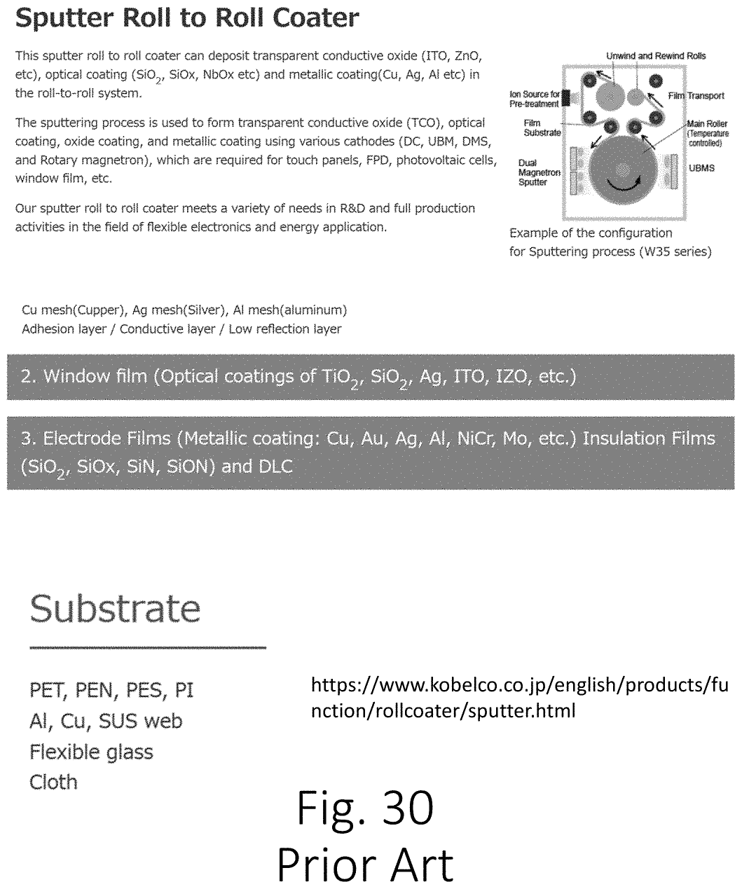

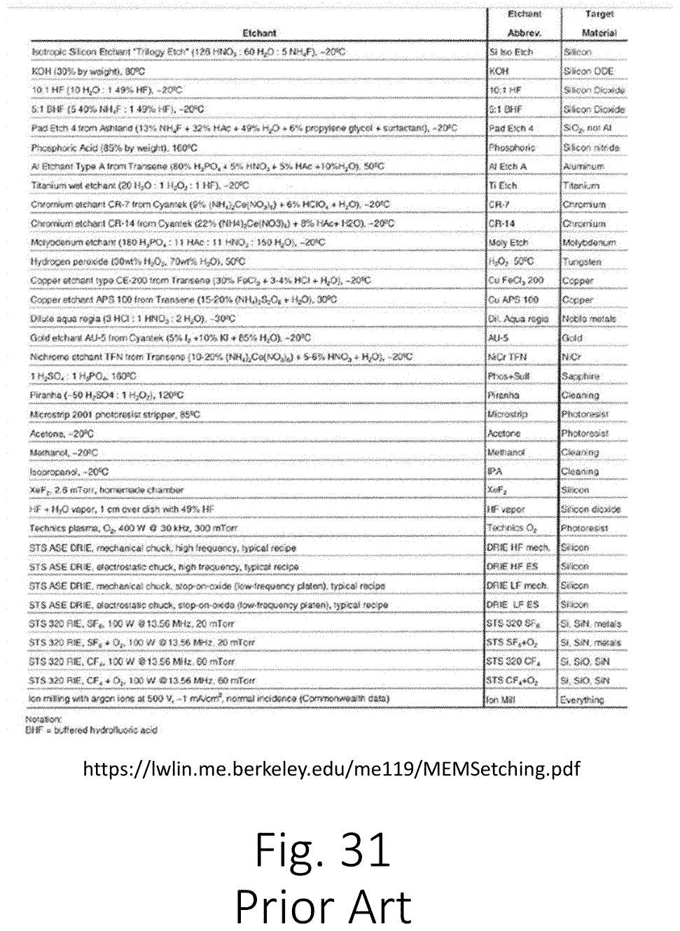

FIGS. 26 through 30 disclose prior art information on capacitors, materials used as dielectric and etchants, and their effectiveness in etching conductors and dielectrics.

The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While this technology is susceptible of embodiment in many different forms, there are shown in the drawings and are herein described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the Figures are merely schematic representations of the present disclosure. As such, some of the components may have been distorted from their actual scale for pictorial clarity.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various Figures (including component diagrams) shown and discussed herein are for illustrative purpose only, and are not drawn to scale.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A capacitor device comprising:
a plurality of first conductor layers fabricated from a first material;
a first dielectric layer above at least one of the first conductor layers and a second dielectric layer below the at least one first conductor layer, such that the dielectric layers sandwich the at least one first conductor layer;
at least one second conductor layer fabricated from a second material, the second conductor layer also being sandwiched between two dielectric layers; wherein
each of the first conductor layers are electrically connected to at least one other first conductor layer, and each of the second conductor layers are electrically connected to each other, and
each of the second conductor layers are not electrically connected to any of the first conductor layers.

2. The device according to claim 1, wherein at least one of the first or second conductor layers is aluminum or an alloy thereof.

3. The device according to claim 1, wherein at least one of the first or second conductor layers is copper or an alloy thereof.

4. The device according to claim 1, wherein at least one of the first or second conductor layers is nickel or an alloy thereof.

5. The device according to claim 1, wherein at least one of the first or second conductor layers is titanium or an alloy thereof.

6. The device according to claim 1, wherein at least one of the first or second conductor layers is tungsten or an alloy thereof.

7. The device according to claim 1, wherein at least one of the first or second conductor layers is silicon.

8. The device according to claim 1, wherein at least one of the first or second conductor layers is chromium.

9. The device according to claim 1, wherein at least one of the first or second conductor layers is molybdenum.

10. The device according to claim 1, wherein at least one of the first or second conductor layers is gold.

11. The device according to claim 1, wherein at least one of the first or second conductor layers is silver.

12. The device according to claim 1, wherein the dielectric material is a solid material.

13. The device according to claim 1, wherein an electrical connection point to at least one of the first conductor layers is isolated from an electrical connection point to at least one of the second conductor layers by a layer of insulating material.

14. The device according to claim 1, wherein an electrical connection point to at least one of the first conductor layers is isolated from an electrical connection point to at least one of the second conductor layers by an air gap between two adjoining dielectric layers.

15. The device according to claim 1, wherein the conductor layers and the dielectric layers are stacked directly on top of one another.

16. The device according to claim 1, wherein the resultant capacitor device is located within an integrated circuit.

17. The device according to claim 1, wherein the resultant capacitor device is rolled into a cylindrical geometry.

18. The device according to claim 1, wherein the conductor layers and dielectric layers are mated to a substrate.

19. The device according to claim 1, wherein the conductor layers and dielectric layers are mated to a substrate that has grooves wider than two times the total thickness of the conductor and dielectric stack.
